(19) United States
(12) Patent Application Publication
(10) Pub. No.: US 2017/0068394 A1
(43) Pub. Date: Mar. 9, 2017

(54) TOUCHSCREEN SYSTEM USABLE IN A VARIETY OF MEDIA

(71) Applicant: Ceebus Technologies, LLC, Boulder, CO (US)

(72) Inventors: Dennis Cahalan, Longmont, CO (US); Richard Deichert, Broomfield, CO (US); John VanLaanen, Louisville, CO (US); Ted Noonan, Louisville, CO (US); Michel Hendricks, Boulder, CO (US); David Cahalan, Bozeman, MT (US)

(21) Appl. No.: 15/091,372

(22) Filed: Apr. 5, 2016

Related U.S. Application Data
(63) Continuation of application No. 14/844,916, filed on Sep. 3, 2015.

(51) Int. Cl. G06F 3/042

(52) U.S. Cl. CPC G06F 3/0428

(57) ABSTRACT

An optical touch screen, suitable for use underwater and in air comprises a transparent waveguide covering an optional display, which is surrounded by light sources that couple light into the waveguide and sensors that monitor the intensity of light propagating through the waveguide, where light intensity responses are attenuated when the touch surface of the waveguide is touched, as result of disturbing (or frustrating) internally reflected light, and where the locations of such touch events are determined using line equations. The optical touch screen system implements various techniques to allow housing in a waterproof case, and seamless, reliable function underwater and in air.

### FIELD OF THE DISCLOSURE

The present disclosure relates to touch screen systems. More particularly, the present disclosure relates to touch screens employing a waveguide and usable in a variety of media.

### BACKGROUND

Scuba diving is a unique and enjoyable recreational experience. It is estimated that, every day, over 75,000 persons participate in the sport at thousands of diving resorts and operations worldwide. In addition, various commercial and military operations utilize scuba divers to perform activities such as search and rescue, salvage, underwater construction and repair activities, and military reconnaissance.

Operationally, one aspect of the uniqueness of diving is that the user interface to dive computers and other underwater equipment is less user-friendly and intuitive than land-based equipment. Making push buttons and other controls waterproof is challenging, which limits the number of controls and the types of controls available. Also, traditional capacitive and resistive touch screens do not work underwater because seawater surrounding the device is interpreted by the device as though the entire screen surface is being touched. Other methods of providing a user interface to diver computers and underwater equipment, such as using a gel-filled membrane over capacitive touch screen, or a pressure-controlled, air-filled membrane over capacitive touch screen are bulky, do not work with gloved hands, are vulnerable to membrane ruptures, etc.

Optical touch screens may hold potential for underwater use. However, existing optical touch screens are not designed to work effectively underwater. For example, access is required to the perimeter of the transparent screen for placement of light sources and sensors. This becomes difficult to implement with a practical underwater housing. In other examples, the edge of a transparent screen is required to be patterned (like a Fresnel lens), the screen is required to be multi-layered in order to establish a regular grid of light paths, collimating lenses are required, or solutions to complex systems of equations are required.

Challenges for optical touch screens include providing an implementation that can 1) easily fit in a pressure-tolerant, waterproof housing, 2) tolerate wide variation in ambient light and temperature, 3) tolerate a large difference in the index of refraction for water and air, 4) yield a simple set of algorithms that are not computationally intensive.

### SUMMARY

Provided is a method for determining location of a touch on a touch-screen which includes emitting a radiation pulse through a waveguide from one or more of a plurality of radiation sources coupled with a lower surface of the waveguide; forming a radiation response profile from the attenuation of each radiation pulse emitted from the plurality of radiation sources, internally reflected through the waveguide and measured at one or more radiation sensors coupled with the lower surface of the waveguide interior to at least one perimeter surface of the waveguide; when a width of the radiation response profile is within a pre-defined range and a magnitude of the radiation response profile meets or exceeds a threshold, determining a response centroid from the radiation response profile; constructing a line equation defining the path between each response centroid and the emitting radiation source such that each line equation extends at an angle relative to every other line equation; calculating points of interception for the line equations; and computing a centroid of the points of interception to establish a valid touch location.

Further provided is a touch screen interface system which includes a waveguide having at least one perimeter surface between an upper surface and an opposite, lower surface; a plurality of radiation sources coupled with the waveguide at the lower surface, interior to the at least one perimeter surface and configured to emit radiation into the waveguide for internally reflected propagation therethrough; a plurality of radiation sensors coupled with the waveguide at the lower surface, interior to the at least one perimeter surface and configured to measure attenuation of radiation internally reflected through the waveguide from one or more of the plurality of radiation sources; and a processor operatively coupled with the radiation sources and the radiation sensors. The processor is configured to cause emission of a radiation pulse from one or more of the plurality of radiation sources through the waveguide; form a radiation response profile from each radiation pulse emitted from the plurality of radiation sources, internally reflected through the waveguide and measured at one or more of the plurality of radiation sensors; determine a response centroid from each radiation response profile having a width within a pre-defined range and a magnitude exceeding a threshold; construct a line equation defining the path between each response centroid and the emitting radiation source such that each line equation extends at an angle to every other line equation; calculate points of interception for the line equations; and compute a centroid of the points of interception to establish a valid touch location.

Also provided is an optical touch screen system which includes a transparent waveguide having a upper touch surface and a lower non-touch surface substantially parallel to the upper touch surface, the surfaces defining therebetween a perimeter having one or more edge surfaces; a plurality of light sources operatively coupled with the waveguide so as to send light into the waveguide through either the upper touch surface or the lower non-touch surface or a combination thereof, such that the light propagates through the waveguide by means of internal reflection; a plurality of light sensors coupled to either the upper touch surface or the lower non-touch surface or a combination thereof, so as to sense intensity of light propagating through the waveguide; wherein with at least one of the plurality of light sources sending light into the waveguide, and in the absence of any touch at the upper touch surface, the light sensors measure relatively large signal strength; wherein with at least one of the plurality of light sources sending light into the waveguide, and in the presence of one or more touches at one or more upper touch surface locations, one or more of the plurality of light sensors measure attenuation in signal strength resulting from escape of some internally reflected light from the waveguide at one of more of the upper touch surface locations; and a processor. The processor is programmed to generate line equations representing attenuated light paths through the waveguide from each of the plurality of light sources to one of the plurality of light sensors or a center location of a group of the plurality of light sensors; and calculate intersections of a plurality of the line equations to relate the one or more of the upper touch surface locations and the sending light sources to determine the upper touch surface touch locations.

### BRIEF DESCRIPTION OF THE FIGURES

FIG. 1 shows a plan view of an example touch screen system in accordance with aspects of the present disclosure;

FIG. 2 shows a side view of the example of FIG. 1 with the display removed for clarity;

FIG. 3A shows a detailed side view of an example touch screen system with multiple light paths emanating from a light source and propagating through a waveguide;

FIG. 3B shows a detailed side view of an example touch screen with a light path emanating from the light source, propagating through a waveguide to a light sensor;

FIG. 3C shows a detailed side view of an example touch screen with a light path emanating from a light source, propagating through a waveguide to a light sensor in the presence of a disruption from a finger contacting the touch surface;

FIG. 4A shows a plan view of an example touch screen with a touch disrupting some of the light paths between a first light source and various sensors;

FIG. 4B shows a plan view of an example touch screen with a touch disrupting some of the light paths between a second light source and various sensors;

FIG. 5 shows a plan view of an example touch screen with a touch disrupting some of the light paths between a light source and various sensors;

FIG. 6 shows a plan view of an example touch screen with a superimposed Cartesian coordinate system and lines whose equations were derived from sensor measurements obtained while the various light sources are turned on.

FIG. 7 shows a plan view of an example touch screen with two touches disrupting some of the light paths between a light source and various sensors;

FIG. 8A shows a plan view of an example touch screen having eight light sources being contacted by two touches;

FIG. 8B shows a plan view of an example touch screen having ten light sources; and

FIG. 9 shows a flow diagram of an example method for determining a touch location on a touch screen.

### DETAILED DESCRIPTION

The present disclosure sets forth a simple touch screen user interface system that works effectively underwater and on the surface (in air), such that the user can freely move in and out of water while the touch screen continues to work seamlessly in both environments to provide the user a more intuitive interface for underwater equipment.

In accordance with one or more embodiments of the disclosure, a touch screen capable of functioning in air and underwater comprises a waveguide, radiation sources and radiation sensors coupled to a touch or non-touch surface of the waveguide and surrounding a display which presents information to a user. The presence of touch events on the exposed touch surface of the transparent waveguide are observed by measuring attenuations in radiation intensity with the radiation sensors as a result of the touch perturbing internal radiation reflections propagating within the waveguide. Qualified sensor responses are used to generate line equations, which are then used to determine the locations of clustered line intercept points, where touch events occur. Various techniques are implemented to allow the device to be housed in a waterproof case, and to function efficiently, reliably and seamlessly underwater and in air.

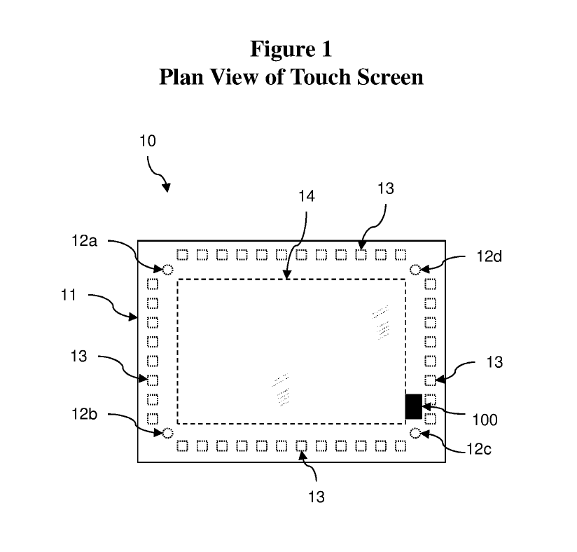

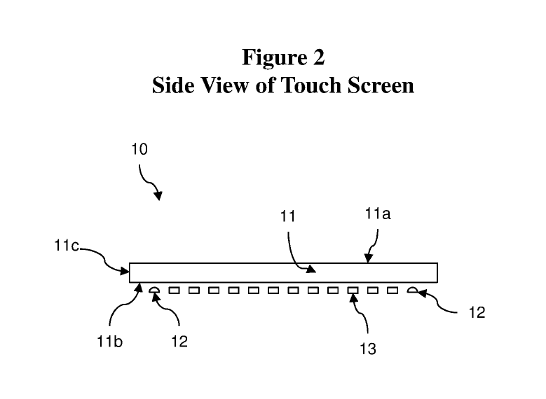

In reference to FIGS. 1 and 2, a touch screen 10 includes a waveguide 11 with an upper touch surface configured to receive a touch or contact of a gloved or ungloved finger, stylus or other touching tool. Separated from upper touch surface 11a (FIG. 2) by a perimeter having one or more perimeter surfaces or perimeter edge surfaces 11c is a lower non-touch surface 11b. Waveguide 11 may be, for example, an optical plate or a transparent sheet.

A plurality of radiation sources 12a, 12b, 12c and 12d and a plurality of radiation sensors 13 are provided adjacent to lower non-touch surface 11b interior to the perimeter defined by one or more perimeter surface 11c. Lower non-touch surface 11b is configured both for coupling radiation emitted from sources 12a, 12b, 12c and 12dinto waveguide 11as well as for coupling radiation from waveguide 11 to radiation sensors 13. In an example, upper touch surface 11a is parallel to lower non-touch surface 11b. Radiation sources 12a, 12b, 12c, 12d may be of any variety configured to emit pulses of radiation detectable by radiation sensors 13 after propagation through waveguide 11. Control of emission of radiation pulses from radiation sources 12 as well as measurement by sensors 13 is provided by a processor 100 operatively coupled thereto.

Referring to FIG. 1, processor 100 may be local to waveguide 11, as shown, for example as a component of display 14 or a component of waveguide 11 itself. As a local component, processor 100 may be in wired or wireless communication with radiation sources 12 and radiation sensors 13 so as to enable performance of a number of actions therewith as described in further detail below. Alternatively, processor 100 may be remote from waveguide 11, for example, as a component of a master desktop, or laptop computer distant from touch screen 10 in wired or wireless communication with radiation sources 12 and radiation sensors 13. In some embodiments, processor 100 may be comprised of a number of dispersed sub-processors which together perform the actions of processor 100. For example, a first sub-processor may perform actions related to controlling radiation sources 12 and radiation sensors 13 while a second sub-processor performs data analysis. In an example, processor 100 includes a collection of embedded Flash microcontrollers such as an SAM-D20 integrated with multi-channel analog to digital converters. In another example, processor 100 includes an ARM® Cortex®-M3. In an embodiment, system 10 includes one or more of a variety of memory components including but not limited to 23A1024 SRAM.

In an example, radiation sources 12a, 12b, 12c and 12d emit light and are provided as infrared light-emitting diodes while radiation sensors 13 measure light intensity and are provided as photo diodes or photo transistors. In an alternative, as light emitters, radiation sources 12a, 12b, 12c and 12d may emit any of a variety of wavelength ranges outside of the infrared spectrum. In another example, radiation sources 12a, 12b, 12c and 12d emit sound the intensity of which, after propagation through waveguide 11, is measurable by radiation sensors 13 which may be, for example, microphones. Neither radiation sources 12a, 12b, 12c and 12d nor radiation sensors 13 are limited to exploiting these example radiation forms.

A display 14 located directly behind waveguide 11 and adjacent to non-touch surface 11b may be used to present information to a user, including icons and other tools with which the user can interact, via touch screen system 10. Radiation sources 12a, 12b, 12c and 12d and radiation sensors 13 may surround display 14 in any of a variety of configurations so that radiation paths connecting the radiation sources 12a, 12b, 12c and 12d and radiation sensors 13 provide adequately dense radiation path coverage over the entire display viewing area and a touch or a plurality of concurrent touches will be detected on upper touch surface 11a. In an example configuration, the radiation paths connecting radiation sources 12a, 12b, 12c and 12d with radiation sensors 13 are adequately dense that a typical finger touch will result in a group of attenuated sensor responses. Some touch screen system embodiments have no display, for example touch pads.

A benefit of providing radiation sources 12 and radiation sensors 13 to lower non-touch surface 11b is that housing the finished assembly in a waterproof case, suitable for underwater use at a range of depths and pressures, is much easier to accomplish than if radiation sources 12 and radiation sensors 13 are located outside the perimeter of the waveguide.

FIG. 2 shows a side view of the example touch screen system of FIG. 1 with display 14 omitted for clarity. The transparent waveguide 11 defines a volume within upper touch surface 11a, lower non-touch surface 11b and the one or more edge surface 11c. Radiation sources 12a, 12b, 12c and 12d and radiation sensors 13 are visible beneath transparent waveguide 11, near non-touch surface 11b.

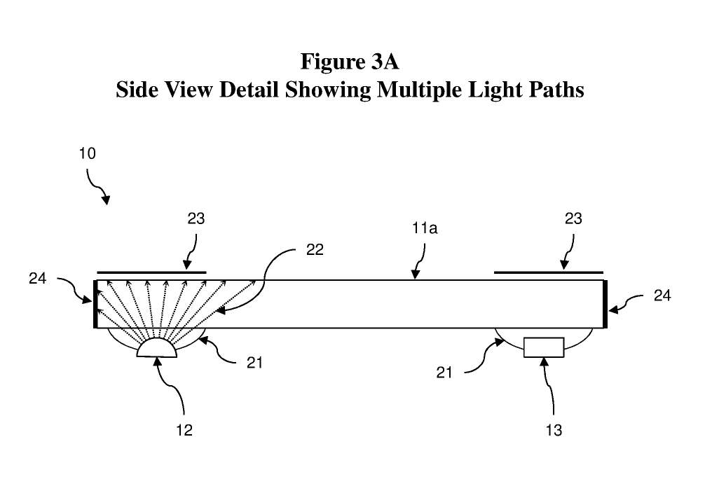

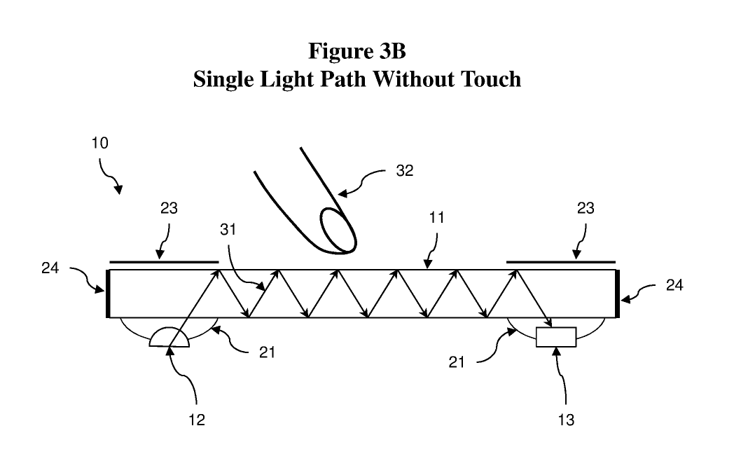

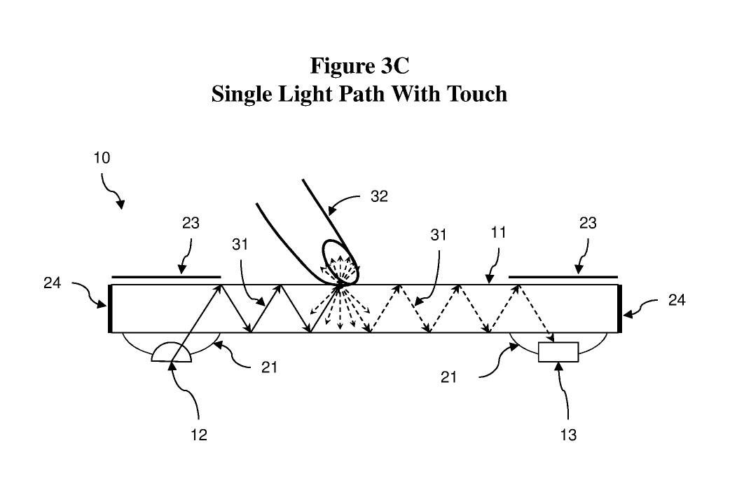

FIGS. 3A, 3B and 3C show detailed side views of a touch screen 10. While, as described above, radiation sources 12 and radiation sensors 13 may be provided to respectively emit and measure intensity of one of a variety of radiation types, the remainder of the disclosure will focus discussion on implementation of sources 12 which emit light and sensors 13 which measure light intensity.

FIG. 3A shows many light paths 22 originating from one of light sources 12. For clarity, light paths 22 are shown truncated at upper touch surface 11a in FIG. 3A. In reality, light paths 22 each propagate down the length of the waveguide 11, for example to the right in FIG. 3A. Some of light paths 22 alternately reflect off of upper touch surface 11a and lower non-touch surface 11b many times before reaching a sensor 13. Other paths among light paths 22 may reflect only a few times at upper touch surface 11a and lower non-touch surface 11b before reaching sensor 13. Light paths closer to being normal with the waveguide upper touch surface 11a, lower non-touch surface 11b or both will tend to lose intensity more rapidly, since much light is transmitted into the surrounding medium. However, as the angle of light paths 22 relative to a normal of the upper touch surface and/or the lower non-touch surface, exceeds some critical angle, essentially no light escapes waveguide 11 into the surrounding medium. The critical angle at a medium interface is the angle relative to the interface normal, where that angle is equal to the arcsine of the ratio of the index of refraction of the surrounding medium divided by the index of refraction of the waveguide material. For example, a glass waveguide with a surrounding medium of air may exhibit a critical angle of 42 degrees. In another example, a glass waveguide with surrounding medium of water may exhibit a critical angle of 62 degrees. At the critical angle and larger-magnitude angles, nearly all light emitted into waveguide 11 remains as internally reflected light within waveguide 11. Some light propagating down waveguide 11 is detected by light sensor 13. Processor 100 forms a light response profile from each light pulse emitted from light sources 12, internally reflected through waveguide 11 and measured at one or more of light sensors 13.

A refractive index-matching material 21 substantially fills in any gaps between sources 12 and waveguide 11 to enable efficient propagation of light therefrom into waveguide 11. Similarly, refractive index-matching material 21 substantially fills in any gaps between waveguide 11 and sensors 13 to enable efficient propagation of light from waveguide 11 to light sensors 13.

Referring to FIG. 3A, in an embodiment, a radiation absorber 24 comprised of one or more radiation absorptive materials is coupled to perimeter surface 11c in order to mitigate reflection of light into waveguide 11 from perimeter surface 11c after propagating once through waveguide 11. Light propagation through the length of waveguide 11 multiple times is thereby avoided. When considering only single-passes of light through the waveguide, complex series equations can be avoided.

Referring again to FIG. 3A, in an embodiment a radiation shield or light shield 23 shadows light sensors 13 from ambient light in order to reduce the amount of ambient light received thereby. In an example, light shield 23 covers one or more of light sensors 13. In another example, light shield 23 covers one or more of light sources 12 in addition to light sensors 13. In some examples, a single structure including radiation absorber 24 and light shield 23 wraps around all outer edges and surfaces of waveguide 11, allowing only a user display to be viewed through the transparent waveguide 11. Radiation shield 23 may cover the upper touch surface so as to be in direct contact therewith or may be distanced therefrom by a small gap.

Referring to FIG. 3B, a single light path 31 propagates from light source 12 through waveguide 11 to light sensor 13. As upper touch surface 11a is not being touched by finger 32, light path 31 propagates through waveguide 11 unperturbed by a series of internal reflections from source 12 to sensor 13.

Referring to FIG. 3C, when finger 32 contacts upper touch surface 11a of waveguide 11, some light propagating along light path 31 is lost. At the point of contact, the external medium is replaced by a finger 32 (or gloved finger), which has a complex/lossy index of refraction which is larger than the external medium. Accordingly, the finger or gloved finger 32 causes a larger critical angle. In an example, a finger or gloved finger contacting a glass waveguide may exhibit a critical angle in the 73 to 90 degree range. At the point of contact of finger 32, the critical angle has changed such that some light passes through finger 32 to be absorbed, and some light is dispersed and reflected back into waveguide 11. A reduction in light intensity is measured by sensor 13 as a result of the touch and the corresponding absorbed light.

As an alternative to refractive index-matching material 21, sources 12 and sensors 13 may be positioned outside perimeter surface 11c of waveguide 11. However, with this arrangement, many light paths between sources 12 and sensors 13 would be direct, and this may complicate detection of touch attenuation. In another alternative, light source(s) 12 and the light sensor(s) 13 may be embedded the in waveguide 11. However, by having the sources and sensors interface to upper touch surface 11a or lower non-touch surface 11b of the waveguide, more light propagating through waveguide 11 undergoes more reflections, and direct light paths between sources and sensors are virtually eliminated. By virtually eliminating the direct light paths in the waveguide, sensors 13 observe a much larger percentage change in signal response between conditions present with an attenuating touch, and conditions when an attenuating touch is not present. Furthermore, with light sources 12 and light sensors 13 coupled to lower non-touch surface 11b of waveguide 11, facilitates accommodation of touch screen 10 within a waterproof housing, and a complex bezel design necessary to withstand water pressure may be avoided.

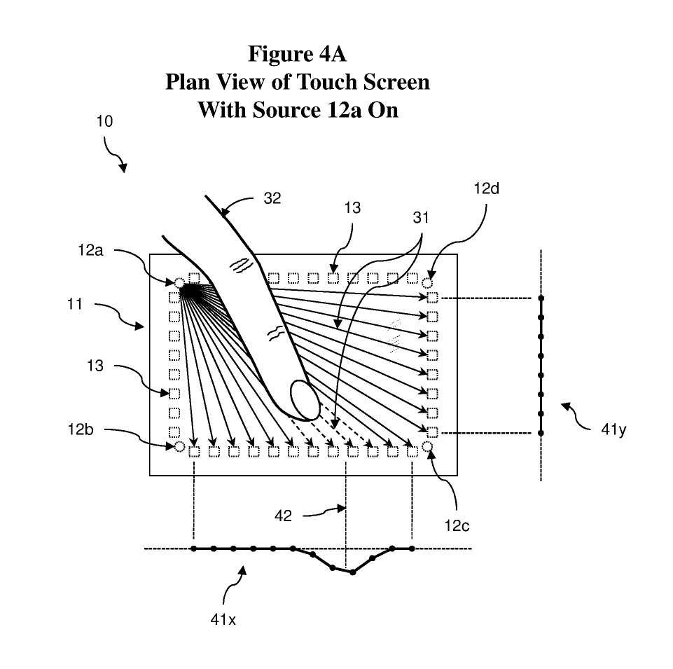

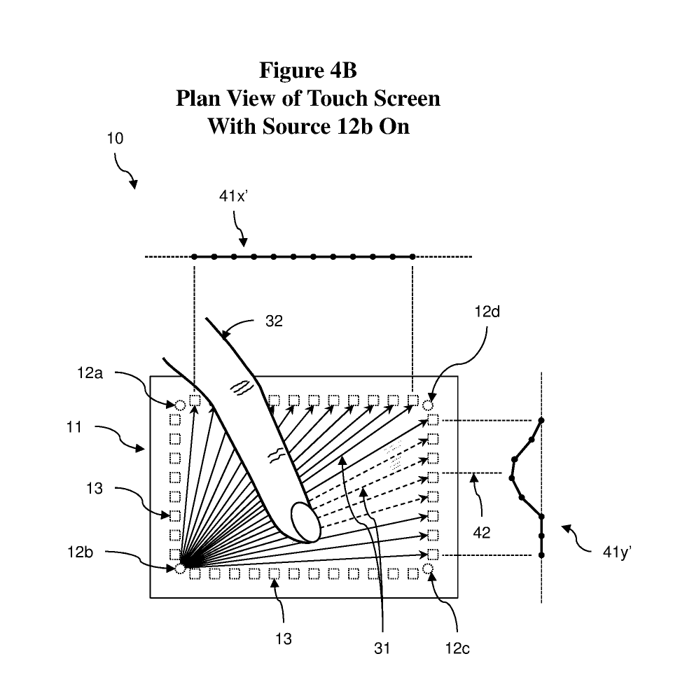

FIGS. 4A and 4B show plan views of touch screen 10 with light sources 12a and 12b alternately emitting light while a finger 32 touches upper touch surface 11a. With light source 12a turned on as shown in FIG. 4A, the touch of finger 32 on upper touch surface 11a results in some of light paths 31 being disrupted. At the lower edge of FIG. 4A, example responses 41x of light sensors 13 that are located inside the lower edge of the waveguide 11 are attenuated, due to the touch event. Meanwhile, example responses 41y are not attenuated since sensors located inside the right edge of perimeter surface 11c do not measure any touch effect on their light paths 31.

With light source 12b turned on as shown in FIG. 4B, the touch of finger 32 on upper touch surface 11a results in some of light paths 31 being disrupted. At the right edge of the FIG. 4B, example responses 41y′ of light sensors 13 that are located inside the right edge of perimeter surface 11c are attenuated, due to the touch event. Meanwhile, example responses 41x′ are not attenuated as sensors located inside the lower edge of perimeter surface 11c do not measure any touch effect on their light paths 31.

FIGS. 4A and 4B show light sources 12a and 12b being alternately turned on. However, since touch screen 10 has been additionally provided with light sources 12c and 12d, light sources 12c and 12d would also be individually turned on, and the corresponding light sensor responses 41 would be measured. In addition to light sensor responses being measured for each of the light sources being turned on, the light sensor responses would also be measured for the condition where all light sources are turned off, in order to measure ambient light for each sensor. The ambient light response measured for each sensor 13 may then be subtracted, by processor 100, from the total response during touch attenuation so as to remove, from responses 41, wide variations in ambient light which may otherwise be present as touch screen 10 is moved within or between media such as air and water.

In addition to ambient light effects, thermal sensitivity of sensors 13 and the difference in the indices of refraction for media in which touch screen system 10 is used must also be minimized. Light sensors are inherently sensitive to temperature, which can result in wide variations in measured response 41 when, for example, touch screen system 10 moves between air and water or two other distinct media. Similarly, the indices of refraction for air and water, 1.00 and 1.33, respectively, are quite different, also drastically affecting the measured response 41. To track both temperature sensitivity and the index of refraction for the surrounding medium, as well as to correct for those effects, a measure of average sensor response is tracked by processor 100, in order to dynamically adjust qualification thresholds for sensor response profiles.

In order to distinguish between inadvertent and intentional touches on touch screen 10, in some embodiments, a pre-established range of acceptable, qualified response profile widths are used by processor 100 to determine a valid touch. Since, for a range of gloved and ungloved finger sizes, widths of the response profiles 41x, 41y, 41x′ and 41y′ will vary. For example, a slender finger may result in a fairly narrow response profile width while a wider finger may result in a response profile width that is somewhat greater. Meanwhile inadvertent touches, are most likely narrower than a finger touch or wider than a finger touch in one or more dimensions. Processor 100 is programmed to compare response profile widths to the pre-established range of acceptable widths to further process those response profiles having qualified, acceptable widths and to ignore those response profiles having widths outside the pre-established range.

In an example, once a response profile, such as 41x or 41y, is determined by processor 100 to be of a width within the pre-established range, and the response attenuation is determined by processor 100 to be of a sufficient magnitude (such that it exceeds some threshold), the centroid of the response profile is determined by processor 100 and used to determine a touch location center 42, along a row of sensors. In other embodiments, the response peak, weighted response peak, curve-fitted response peak, or other means can be used to determine the center touch coordinates.

Using a selected means, for example the centroid of the response profile, touch location center 42 is determined for emission from each light source 12a, 12b, 12c or 12d individually. For individual emission from one or more of light sources 12a, 12b, 12c,and 12d, a valid touch may not be found. However, once two or more qualified response profiles have been found for a corresponding number of emitting light sources 12, the location of a single touch event can be determined in two dimensions by processor 100. Then, established location is reconciled and/or matched with an interactive portion of a display coupled to the waveguide adjacent to a lower surface so that the touch affects an interaction between user finger 32 and the display.

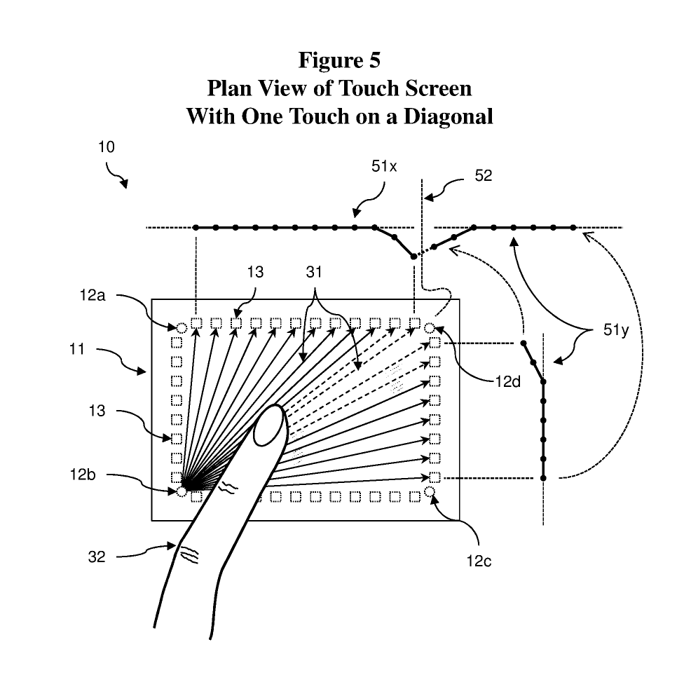

Depending on where a touch occurs relative to sources 12a, 12b, 12c and 12d, the widths of response profiles 41 may vary. If a touch occurs close to a source 12, the corresponding response profile 41 will be wider than if the same touch were to occur closer to a corresponding sensor 13. The shadow being cast is larger, as the touch moves toward the source 12. In addition to the shadow getting larger, positional accuracy, as determined by the response profile 41, tends to decrease. By qualifying a response profile 41 based on its width measurements a touch which occurs too close to a light source 12 may be disregarded. In a typical example, only one response out of four, will be discarded, as a result of a touch occurring on the touch surface in a corner of the display area.

Where sources and sensors are arranged as shown in FIGS. 4, there is the possibility that a touch will happen along either diagonal, lying near lines defined between opposing light sources 12a and 12c, or 12b and 12d. This condition is shown in FIG. 5. As may be seen, the response to light source 12b is partially seen on response profile 51x and partially seen on response profile 51y. By rotation and translation of example profile response 51y to the top, as shown, example response profile 51y provides a continuation to example response profile 51x. Thus, a collective example response profile is generated which wraps around the corner where source 12d is located and has a response center 52. As in the cases of FIG. 4, the collective response profile of FIG. 5 may be used in further processing to determine one or more touch locations, depending on response profile width and/or, magnitude of attenuation and/or other considerations.

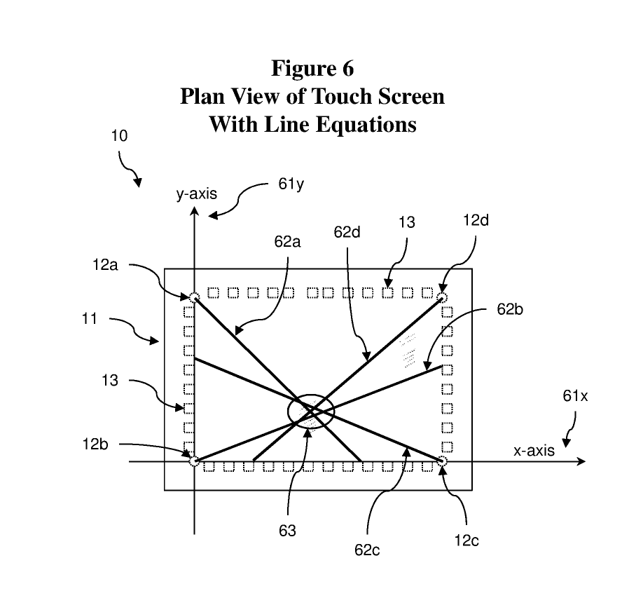

FIG. 6 shows touch screen 10 under the conditions of a touch event, for example, by finger 32 as illustrated in FIGS. 4 and 5. In FIG. 6, finger 32 of FIGS. 4 is removed for clarity. In this case, valid touch events were recognized by processor 100 for each of the four lighting conditions, for the four respective light sources 12a, 12b, 12c, and 12d being individually turned on so as to emit light into waveguide 11. Line equations 62a, 62b, 62c and 62d are constructed by processor 100 using the four resulting touch location centers, for example touch location centers 42 as shown in FIG. 4, and locations of their corresponding light sources 12a, 12b, 12c and 12d. In the current embodiment, the line equations are expressed in terms of a Cartesian coordinate system, where the x-axis 61x and y-axis 61y are also shown on the figure. For example, line equation 62a may be expressed as y=−x+8.

Using the line equations 62, intercept points 63 (circled) for those line equations are calculated by processor 100. For example, line equation 62a expressed as y=−x+8 and line equation 62b expressed as y=5x/12 have an intercept at a point (96/17, 40/17). In an example, among all calculated intercept points, qualified intercept points may be those identified as being confined, to some envelope of uncertainty. The envelope diameter, which may be defined in accordance with rules programmed into processor 100, relates to accumulated measurement errors caused by such contributors as thermal change effects, ambient lighting effects, various noise sources, electrical circuit settling time, the shape and size of the touch, whether the finger is gloved or not, whether the touch screen is in water, air or in the presence of beads of water, precipitating rain or snow, or other effects. Under a range of such expected operating conditions, not all of the intercept points will coincide exactly, instead there will be some normal distribution of intercept point locations that fall within the above-mentioned envelope of uncertainty and, for example, cluster around a centroid. The multiple points of interception are interpreted collectively or in part as a valid touch location. In one example, to establish a valid touch location, the centroid may be computed from the multiple intercept points. In another example, a single intercept point among a number may simply be chosen as the best representative of a valid touch location.

In cases where the intercept points are broadly distributed, outside the envelope of uncertainty, those intercepts may be interpreted as multiple touch locations or unintentional touches, depending other qualification criteria and rules programmed into processor 100.

Occurrences of false positive touch events and false negative touch events are preferably minimized based on tradeoffs. Such a design may require only two qualified line equations and one intercept point, or perhaps three qualified line equations and three tightly clustered intercept points, or a variety of qualification criteria can be used in determining the two-dimensional location of a valid touch. For example, in reference to FIG. 6, since there are four line equations, there can be as many as six intercept points. It may be for a valid touch that not all of those intercept points are tightly grouped within the above-mentioned envelope of uncertainty. For a practical application, it may desirable to allow one or two outliers to fall outside the envelope of uncertainty, and still have a valid touch event.

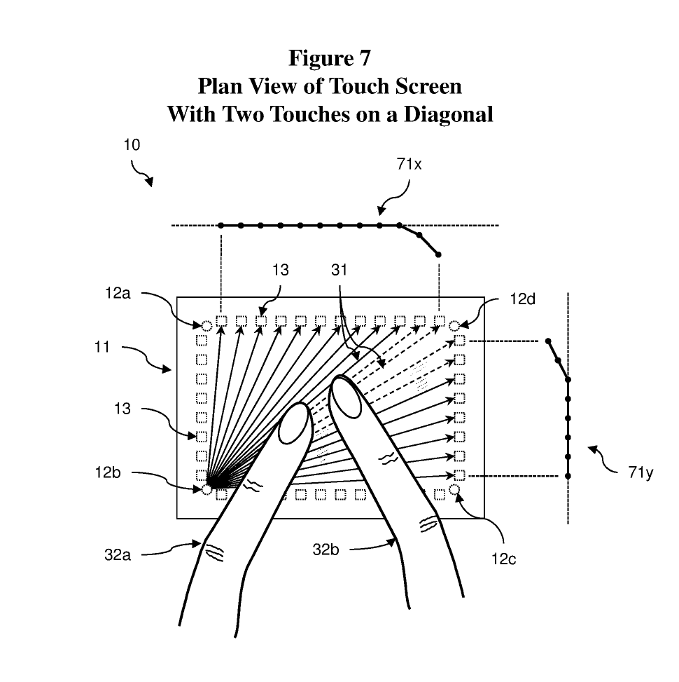

The above discussion focuses on single touch locations on upper touch surface 11a. FIG. 7 shows a scenario in which two fingers 32a and 32b touch upper touch surface 11a. Referring to FIG. 7, both fingers 32a and 32b lie near the diagonal defined between light sources 12b and 12d. Of course, fingers 32a and 32b may be positioned anywhere on touch screen 10. Nevertheless, as shown, one finger 32a shadows the other finger 32b, while light source 12b is emitting light. The result is a response profile 71x combined with 71y in which it is difficult to distinguish between the two touch locations. Of course, it may become more clear that there are two touch locations, once the responses associated with light source 12a or 12c are measured. Nevertheless, from the response associated with light source 12b (or 12d), depending on the response profile width, it is difficult to determine the exact locations of the touches, relative to the line defined between light sources 12b and 12d.

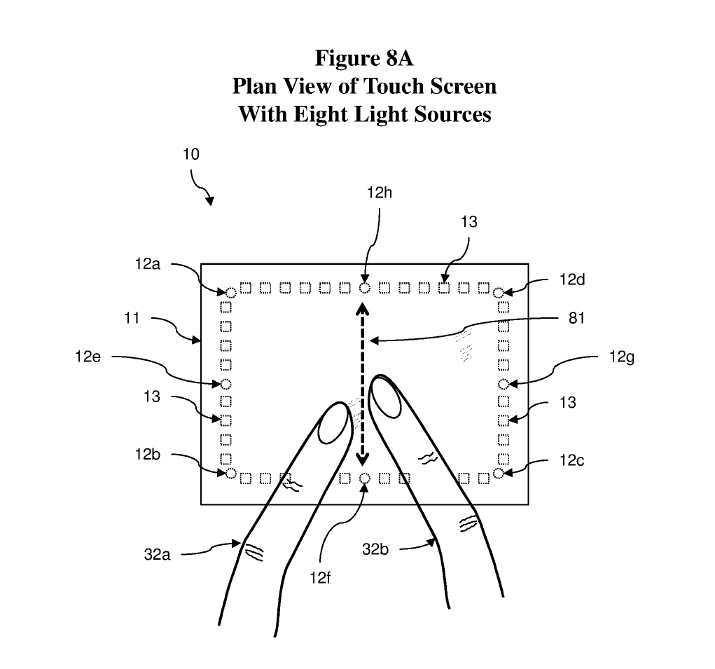

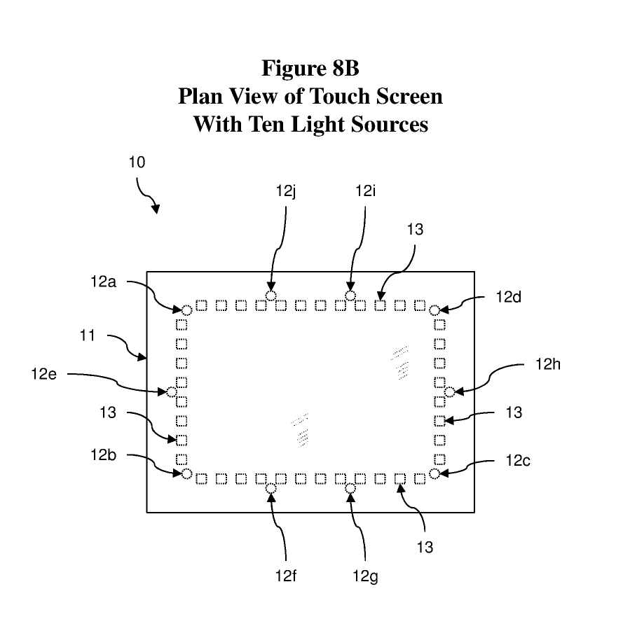

Other embodiments such as those represented in FIGS. 8A and 8B are contemplated to account for ambiguity of touch locations in instances where there are two or more simultaneous touches, for example, as shown in FIG. 7. Referring to FIG. 8A, eight light sources 12a-h are provided. It may be seen that during emission from either of light sources 12f or 12h, there is an unobstructed light path 81 between the two touch locations corresponding to fingers 32a and 32b. Therefore, the responses corresponding to emission from either source 12f or 12h would present two separate and distinct dips (or attenuation regions) corresponding to the two touches. Thus, two separate line equations would be available and resolution of two separate touch locations is possible. In such configurations, many qualified line equations may be used which may result in numerous equation intercept points. The numerous equation intercept points would be clustered around separate centroids for various touch locations.

Referring to FIG. 8B, ten sources 12a-j are provided. In an example, sensors 12e, 12f, 12g, 12h, 12i and 12j are located behind the sensors. Since both sources 13 and sensors 12 are coupled into the waveguide 11 through the non-touch surface (or the touch surface), the light paths emanating from sources 12 are not blocked or shadowed by the sensors 13.

While FIGS. 1 and 4-7 suggest four light sources 12, FIG. 8A suggests eight light sources and FIG. 8B suggests ten light sources, different numbers of light sources may be used. For example, a number of light sources greater than ten may be employed to resolve more touch locations. While fewer light sources than light sensors may be provided to reduce settling time, some embodiments may have more light sources than light sensors, and other embodiments may have equal numbers of light sources and light sensors.

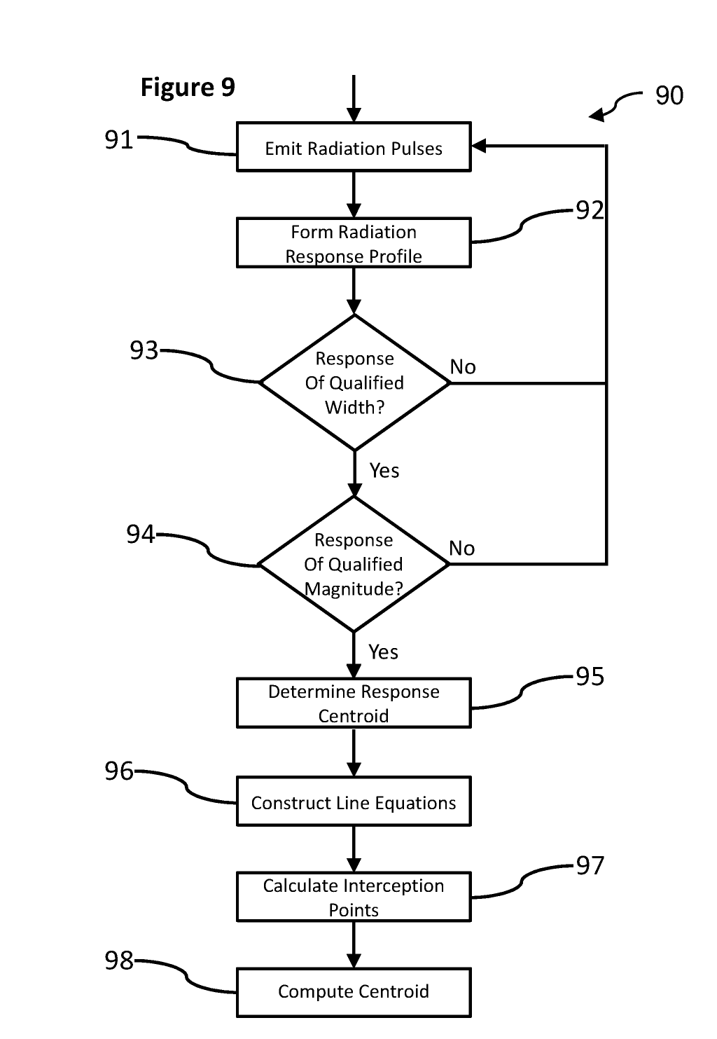

FIG. 9 shows a flow diagram of an example method for determining a touch location on a touch screen. Method 90 may be performed, for example, by processor 100 according to instructions provided thereto for example by programming. Programming may be provided in a non-volatile form such that it is not intended to be modified by an end user or may be provided to a storage medium readable by processor 100. In some examples, the programming is provided with updates distributed by a manufacturer on physical storage media or through a communication network. At 91, a radiation pulse(s) is/are emitted through a waveguide from one or more of a plurality of radiation sources. At 92, a radiation response profile is formed from the attenuation of each radiation pulse emitted from the plurality of radiation sources, internally reflected through the waveguide and measured at one or more radiation sensors coupled with a lower surface of the waveguide. At 93 it is determined whether a width of any radiation response profile is within a pre-defined range. For example, it may be determined whether the radiation response profile is between about 5 mm and about 15 mm. If the width of the radiation response is not within the pre-defined range, additional radiation pulses are emitted at 91.

When a width of any radiation response profile is within a pre-defined range, it is then determined at 94, whether a magnitude of that radiation response profile exceeds a dynamic threshold (based on ambient light levels and source and sensor thermal conditions). If the threshold is not exceeded, process 90 returns to emission of radiation pulses at 91. When a magnitude of the radiation response profile exceeds the threshold, the resulting profile is considered a qualified profile, and a response centroid is determined from the radiation response profile at 95.

At 96, a line equation is constructed to define the path between each response centroid and the emitting radiation source such that each line equation extends at an angle to every other line equation. At 97, points of interception for the line equations are calculated and further evaluated based on the above-mentioned envelope of uncertainty such that interception points within the envelope are retained and those outside the envelope are disregarded. In order to establish the location of one or more valid touch, at 98, a centroid of the interception points is computed. Steps 91 to 98 are only illustrative and other alternatives can also be provided where one or more steps are added, one or more steps are removed, or one or more steps are provided in a different sequence without departing from the scope of the claims herein.

Aspects of touch screen 10, other than the number and locations of light sources, may also be varied. For example, embodiments of a touch screen system described herein may be incorporated into one of many different types of systems that may be used in air or underwater, and that may be utilized by recreational, commercial, industrial and military industries. Aspects of a touch screen system constructed in accordance with the present disclosure may be incorporated into a wrist-mounted, handheld or console dive computer, or may be incorporated into a case used for housing conventional cell phones, tablets or other devices, or may be used in other underwater devices that require a user interface. In an example, processor 100, is a component of the device into which the present system is incorporated.

Those skilled in the art can readily recognize that numerous variations and substitutions may be made to disclosed touch screen systems and components thereof, their use, and their configuration to achieve substantially the same results as achieved by the embodiments described herein. Accordingly, there is no intention to limit the disclosure to the disclosed example forms. Many variations, modifications, and alternative constructions fall within the scope and spirit of the disclosure.

1. A method for determining touch location on a touch screen, comprising:
emitting a radiation pulse through a waveguide from one or more of a plurality of radiation sources coupled with a lower surface of the waveguide;
forming a radiation response profile from the attenuation of each radiation pulse emitted from the plurality of radiation sources, internally reflected through the waveguide and measured at one or more radiation sensors coupled with the lower surface of the waveguide interior to at least one perimeter surface of the waveguide;
when a width of the radiation response profile is within a pre-defined range and a magnitude of the radiation response profile meets or exceeds a threshold, determining a response centroid from the radiation response profile;
constructing a line equation defining the path between each response centroid and the emitting radiation source such that each line equation extends at an angle relative to every other line equation;
calculating points of interception for the line equations; and
computing a centroid of the points of interception to establish a valid touch location.

2. The method as set forth in claim 1, further comprising:
retrieving levels of ambient radiation sensed at the plurality of radiation sensors while no radiation pulses are being actively emitted from the radiation sources; and
subtracting the levels of ambient radiation from each radiation response profile.

3. The method as set forth in claim 1, further comprising:
retrieving a radiation response profile from each radiation pulse sensed, from an actively emitting radiation source, in the absence of touch-attenuation in order to establish a baseline radiation response profile; and
subtracting the baseline radiation response profile from each radiation response profile.

4. The method as set forth in claim 1 further comprising reconciling the established location with an interactive portion of a display coupled to the waveguide adjacent to a lower surface.

5. A touch screen interface system, comprising:
a waveguide having an upper surface and an opposite, lower surface and at least one perimeter surface therebetween;
a plurality of radiation sources coupled with the waveguide at the lower surface, interior to the at least one perimeter surface and configured to emit radiation into the waveguide for internally reflected propagation therethrough;
a plurality of radiation sensors coupled with the waveguide at the lower surface, interior to the at least one perimeter surface and configured to measure attenuation of radiation internally reflected through the waveguide from one or more of the plurality of radiation sources;
a processor operatively coupled with the radiation sources and the radiation sensors, the processor configured to:
cause emission of a radiation pulse from one or more of the plurality of radiation sources through the waveguide;
form a radiation response profile from each radiation pulse emitted from the one or more of the plurality of radiation sources, internally reflected through the waveguide and measured at one or more of the plurality of radiation sensors;
determine a response centroid from each radiation response profile having a width within a pre-defined range and a magnitude exceeding a threshold;
construct a line equation defining the path between each response centroid and the emitting radiation source such that each line equation extends at an angle to every other line equation;
calculate points of interception for the line equations; and
compute a centroid of the points of interception to establish a valid touch location.

6. The system as set forth in claim 5, wherein the processor is further configured to:
retrieve levels of ambient radiation sensed at the plurality of radiation sensors while no radiation pulses are being emitted from the radiation sources; and
subtract the levels of ambient radiation from each radiation response profile.

7. The system as set forth in claim 5, wherein the processor is further configured to:
retrieve a radiation response profile from each radiation pulse sensed at the plurality of radiation sensors in the absence of touch-attenuation in order to establish a baseline radiation response profile; and
subtract the baseline radiation response profile from each radiation response profile.

8. The system as set forth in claim 5, further comprising a display adjacent to the waveguide lower surface, wherein the processor is further configured to reconcile the valid touch location with an icon or tool presented to the display.

9. The system as set forth in claim 5, further comprising at least one ambient radiation shield coupled with the upper surface at one or more positions adjacent to the waveguide perimeter so as to reduce entry of ambient radiation into the waveguide.

10. The system as set forth in claim 5, further comprising at least one radiation absorber coupled with the waveguide perimeter surface so as to reduce internal reflection, at the waveguide perimeter surface or surfaces, of the radiation emitted from the plurality of radiation sources.

11. An optical touch screen system, comprising:
a transparent waveguide having a upper touch surface and a lower non-touch surface substantially parallel to the upper touch surface, the surfaces defining therebetween a perimeter having one or more edge surfaces;
a plurality of light sources operatively coupled with the waveguide so as to send light into the waveguide through either the upper touch surface or the lower non-touch surface or a combination thereof, such that the light propagates through the waveguide by means of internal reflection;
a plurality of light sensors coupled to either the upper touch surface or the lower non-touch surface or a combination thereof, so as to sense intensity of light propagating through the waveguide;
wherein with at least one of the plurality of light sources sending light into the waveguide, and in the absence of any touch at the upper touch surface, the light sensors measure relatively large signal strength;
wherein with at least one of the plurality of light sources sending light into the waveguide, and in the presence of one or more touches at one or more upper touch surface locations, one or more of the plurality of light sensors measure attenuation in signal strength resulting from escape of some internally reflected light from the waveguide at one of more of the upper touch surface locations; and
a processor programmed to:
generate line equations representing attenuated light paths through the waveguide from each of the plurality of light sources to one of the plurality of light sensors or a center location of a group of the plurality of light sensors; and
calculate intersections of a plurality of the line equations to determine the upper touch surface touch location or touch locations.

12. The optical touch screen system of claim 11, further comprising, coupled adjacent to lower non-touch surface and surrounded by the plurality of light sources and the plurality of light sensors, a display configured to provide information to a user.

13. The optical touch screen system of claim 11, further comprising a waterproof housing surrounding the waveguide, the plurality of light sources, the plurality of light sensors and the processor.

14. The optical touch screen system of claim 11, wherein the processor is configured to generate line equations only when one or more of the plurality of light sensors measure a light signal attenuation magnitude exceeding a fixed threshold.

15. The optical touch screen system of claim 11, wherein the processor is configured to generate line equations only when one or more of the plurality of light sensors measure a light signal attenuation magnitude exceeding a dynamic threshold determined for individual light source/light sensor pairs by periodic measurement of average quiescent signal strengths at one or more of the plurality of light sensors while cycling on each of the plurality of light sources.

16. The optical touch screen system of claim 11, wherein the processor is configured to generate a line equation only when one or more of the plurality of light sensors measure a light signal attenuation response within a pre-defined range of widths.

17. The optical touch screen system of claim 11, further comprising a refractive-index-matching material optically coupling the plurality of light sources, the plurality of light sensors or both with the waveguide.

18. The optical touch screen system of claim 11, further comprising a light-absorbing material contacting the one or more edge surfaces so as to reduce the amount of light internally reflected off the one or more edge surfaces with which the material is in contact.

19. The optical touch screen system of claim 11, further comprising an ambient radiation shield coupled to the waveguide proximal to the light sensors so as to reduce ambient light detection by the sensors.

20. The touch screen interface system as set forth in claim 11, wherein the plurality of light sensors are positioned relative to the plurality of light sources such that direct light paths are not emitted from the plurality of light sources through the waveguide to the plurality of light sensors.
